(19) United States
(12) Patent Application Publication
(10) Pub. No.: US 2009/0307761 A1
(43) Pub. Date: Dec. 10, 2009

(54) ACCESS AUTHORITY SETTING METHOD AND APPARATUS

(75) Inventor: Satoshi Iyoda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/542,360

(22) Filed: Aug. 17, 2009

Related U.S. Application Data
(63) Continuation of application No. PCT/JP2007/054557, filed on Mar. 8, 2007.

(51) Int. Cl. G06F 21/00; G06F 15/173; G06F 9/455

(52) U.S. Cl. 726/4; 709/226; 718/1

(57) ABSTRACT

An access authority setting method includes: detecting an action including activation of a virtual machine, stop of the virtual machine or a movement of the virtual machine between physical servers; and setting access authority required for a state after the action to a related apparatus among a connection apparatus and a disk apparatus in a system. By dynamically setting the access authority to the connection apparatus or disk apparatus according to an operation state of the virtual machine, the unauthorized access is prevented and the improvement of the security is realized.

### CROSS-REFERENCE TO RELATED APPLICATIONS

This application is a continuing application, filed under 35 U.S.C. section 111(a), of International Application PCT/JP2007/054557, filed Mar. 8, 2007.

### FIELD

This technique relates to a technique for setting access authority in a system executing a Virtual Machine (VM).

### BACKGROUND

The technology, which is called VM, enables to easily prepare a new server and to change uses of the servers by virtualizing the servers. Furthermore, in order to cope with failures or maintenance of physical servers or to conduct the load distribution, a function is provided that the VM moves between plural physical servers. The movement of the VM includes two kinds of movements, which are static movement and dynamic movement. Namely, in the static movement, the VM is activated on another server after temporarily stopping the VM, and in the dynamic movement, the VM is moved in an operating state.

For example, a system configuration as depicted in FIG. 38 is presupposed. A server 1 is connected with a network switch through a Network Interface Card (NIC), and user terminals A and B are connected to the network switch. In addition, the server 1 is connected with a fibre channel switch through a Host Bus Adapter (HBA), and the fibre channel switch is connected with a storage apparatus. The storage apparatus includes a host Operating System (OS) activation disk and VM activation disks A and B. In an example of FIG. 38, on the host OS1 of the server 1, two VMs “VM-A” and “VM-B” are operating, and a virtual switch and a virtual disk allocation table are set on the host OS1. By the virtual switch, the user terminal A can access only a virtual NIC of the VM-A, and the user terminal B can access only a virtual NIC of the VM-B. In addition, by the virtual disk allocation table, the virtual disk of the VM-A is associated with the VM activation disk A in the storage apparatus, and the virtual disk of the VM-B is associated with the VM activation disk B in the storage apparatus.

In such a system configuration, according to conventional arts, the access right to the server 1 is always set in the network switch to a Local Area Network (LAN, here, Virtual LAN (VLAN)) to which the user terminal A belongs and a LAN (here, VLAN) to which the user terminal B belongs. In addition, the access right is always set in the fibre channel switch to the VM activation disks A and B. These access rights are fixed, and even when either of the VMs is being stopped, the access right cannot be changed. In case of the normal server, the access right to the server is not abused during the stop. However, the host OS is operating even while the VM is stopping, and there is a problem that, when the host OS is invaded, the access right is abused and the invader can access a Storage Area Network (SAN) and LAN, to which the invader cannot originally access.

In addition, when a system configuration as depicted in FIG. 39 is presupposed, it can be understood that a further problem exists. Namely, servers 2 and 3 are connected with a network switch through NICs, and are further connected to a fibre channel switch through HBA. User terminals C and D are connected to the network switch and a storage apparatus is connected with the fibre channel switch. The storage apparatus includes host OS activation disks 2 and 3 and VM activation disks C and D. In an example of FIG. 39, VM-C is executed on the host OS2 of the server 2, and VM-D is executed on the host OS3 of the server 3. However, there is a case where the VM-C moves to the server 3. In such a case, it is necessary to set, in the network switch, the access rights enabling not only the access to the server 2 but also the access to the server 3, for a LAN (here, VLAN) of the user terminal C, which can access the VM-C. In addition, the access right enabling not only the server 2 but also the server 3 to access the VM activation disk C in the storage apparatus has to be set in the fibre channel switch. Then, there is a problem that, when the host OS in either of the servers 2 and 3 is invaded, the access rights to all of the VMs in the servers 2 and 3 are robbed. In addition, for example, when a software failure occurs on the host OS of the server 3, the server 3 can access the VM activation disk C therefore, there is possibility that the VM activation disk C is accessed to damage the VM activation disk C or the operation is obstructed. Furthermore, even when the VM-C is moved to the server 3 because it seems the server 2 hangs up, there is a case where the server 2 seemed to be troubled is actually and merely slowed down and it seems that the server 2 stops, when viewed from the outside. When the VM-C is activated on the server 3, which is a movement destination server because such a state cannot be detected, there is possibility that the VM activation disk C is accessed from both of the servers 2 and 3 to damage the VM activation disk C or to obstruct the business on the servers.

In addition, Japanese Laid-open Patent Publication No. 2005-208999 discloses a virtual machine management program for managing and restricting resources other than a processor resource. Specifically, a virtual resource manager request a resource division server to register, change or delete the virtual resource through a personal computer, a virtual resource division function receives this request, updates a virtual resource management DB and a virtual machine management DB based on the request from the virtual resource manager, and requests a virtual machine control function to change resources according to the request from the virtual resource manager. In addition, the virtual machine manager requests to register, change or delete the virtual machine through the personal computer, and the virtual machine division function receives this request, updates the virtual resource management DB and the virtual machine management DB based on the request from the virtual machine manager and requests the virtual machine control function to carry out a processing according to the request from the virtual machine manager. However, in this publication, the aforementioned problem is not considered.

Furthermore, Japanese Laid-open Patent Publication No, 2003-223346 discloses an architecture providing a capability to create and maintain plural instances of a virtual server such as a virtual filer (vfiler) in one server such as a filer. Specifically, the vfiler is a logical division of a network resource and storage resource in a filer platform to establish instances of a multiprotocol server. A subset of a dedicated unit of the storage resource such as a volume or logical subvolume (qtree) and one or more network address resources are allocated to each of the vfilers. In addition, each of the vfilers can access a file system resource of a storage operating system. In order to ensure access control to allocated resources and shared resource, a unique security domain is allocated for each access protocol to each of the vfilers. A vfiler boundary check is carried out by the file system, and it is judged whether or not the current vfier can access to a specific storage resource for a file stored on the requested filer platform. However, this publication also does not consider the aforementioned problem.

Thus, the conventional arts do not consider a problem such as deterioration of the security in the system environment executing the VMs.

Namely, there is no technique to realize an appropriate grant of the access authority in the system environment executing the VMs.

In addition, there is no technique to enhance the security in the system environment executing the VMs.

Furthermore, there is no technique to prevent unappropriate accesses in the system environment in which the VMs are executed.

### SUMMARY

According to one aspect of this technique, an access authority setting method includes: detecting an action including activation of a virtual machine, stop of the virtual machine or a movement of the virtual machine between physical servers; and setting access authority required for a state after the action to a relative apparatus among a connection apparatus and a disk apparatus in a system.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a system outline relating to an embodiment of this technique;

FIG. 2 is a diagram depicting an example of data stored in a utilization resource data storage of a server 1;

FIG. 3 is a diagram depicting an example of data stored in a utilization resource data storage of a server 2;

FIG. 4 is a diagram depicting an example of data stored in a utilization resource data storage of a server 3;

FIG. 5 is a diagram depicting an example of data stored in a LAN connection data storage in a network switch;

FIG. 6 is a diagram depicting an example of data stored in a SAN connection data storage of a fibre channel switch;

FIG. 7 is a diagram depicting an example of data stored in an access data storage of a storage apparatus;

FIG. 8 is a diagram depicting a first portion of a processing flow of a preliminary setting processing;

FIG. 9 is a diagram depicting a state of a server VM table;

FIG. 10 is a diagram depicting a second portion of the processing flow of the preliminary setting processing;

FIG. 11 is a diagram depicting an example of data stored in a switch information section of a FC table;

FIG. 12 is a diagram depicting an example of data stored in a disk information section of the FC table;

FIG. 13 is a diagram depicting a state of a LAN table;

FIG. 14 is a diagram depicting a processing flow of an initial stop processing;

FIG. 15 is a diagram depicting a state of the disk information section of the FC table;

FIG. 16 is a diagram depicting the state of the LAN table;

FIG. 17 is a diagram depicting a processing flow of VM stop;

FIG. 18 is a diagram depicting a processing flow of VM activation;

FIG. 19 is a diagram depicting the state of the server VM table;

FIG. 20 is a diagram depicting a first portion of a processing flow of VM static movement;

FIG. 21 is a diagram depicting the state of the server VM table;

FIG. 22 is a diagram depicting a second portion of the processing flow of the VM static movement;

FIG. 23 is a diagram depicting the state of the server VM table;

FIG. 24 is a diagram depicting the state of the server VM table;

FIG. 25 is a diagram depicting the state of the disk information section of the FC table;

FIG. 26 is a diagram depicting the state of the LAN table;

FIG. 27 is a diagram depicting a third portion of the processing flow of the VM static movement;

FIG. 28 is a diagram depicting the state of the server VM table;

FIG. 29 is a diagram depicting a first portion of a processing flow of VM dynamic movement;

FIG. 30 is a diagram depicting the state of the server VM table;

FIG. 31 is a diagram depicting the state of the disk information section of the FC table;

FIG. 32 is a diagram depicting the state of the LAN;

FIG. 33 is a diagram depicting a second portion of the processing flow of the VM dynamic movement;

FIG. 34 is a diagram depicting the state of the server VM table;

FIG. 35 is a diagram depicting another example of the second portion of the processing flow of the VM dynamic movement;

FIG. 36 is a diagram depicting a third portion of the processing flow of the VM dynamic movement;

FIG. 37 is a functional block diagram of a computer;

FIG. 38 is a diagram to explain a problem of a conventional art; and

FIG. 39 is a diagram to explain a problem of a conventional art.

### DESCRIPTION OF EMBODIMENTS

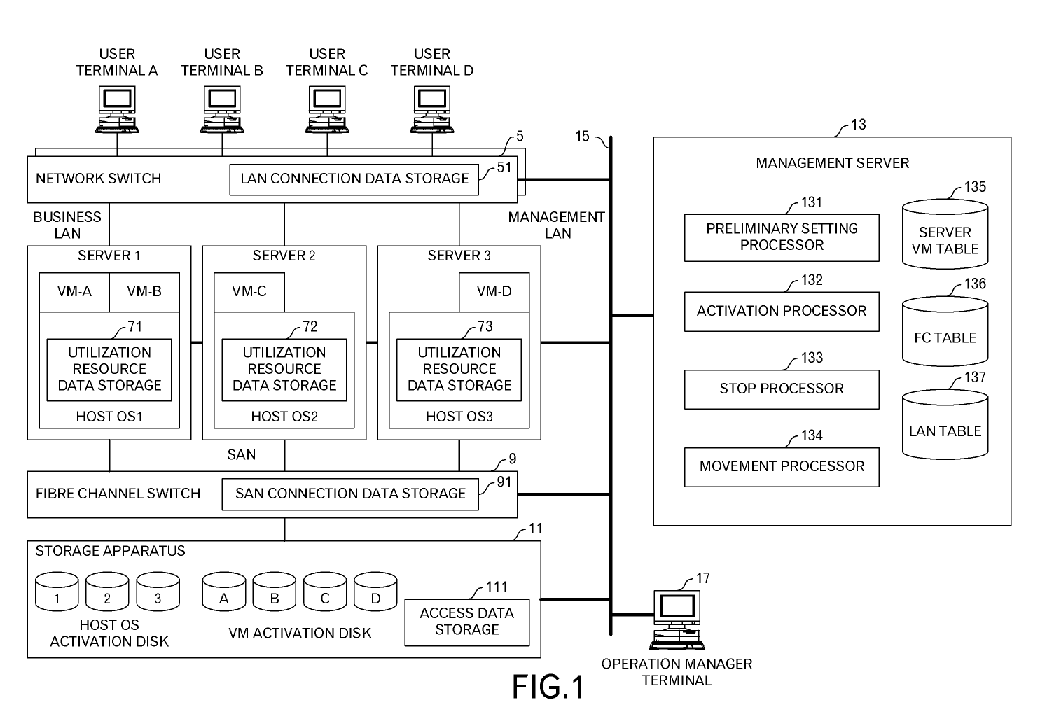

FIG. 1 depicts a system outline relating to embodiments in this technique. The system of FIG. 1 includes three servers, and a host OS1 is executed on the server 1, a host OS2 is executed on the server 2, and a host OS3 is executed on the server 3. The host OS1 manages a utilization resource data storage 71, the host OS2 manages a utilization resource data storage 72, and the host OS3 manages a utilization resource data storage 73. The VMs can be executed on the host OS1 to OS3, and at the time of FIG. 1, VM-A and VM-B are executed on the host OS1, VM-C is executed on the host OS2, and VM-D is executed on the host OS3.

The servers 1 to 3 are connected to a business LAN, and a network switch 5 is connected to the business LAN. The network switch 5 includes a LAN connection data storage 51. In addition, plural user terminals (user terminals A to D in FIG. 1) are connected to the network switch 5. In this embodiment, it is presupposed that the user terminal A accesses the VM-A, the user terminal B access the VM-B, the user terminal C access the VM-C, and the user terminal D accesses the VM-D.

In addition, the servers 1 to 3 are connected with a Storage Area Network (SAN), and a fibre channel switch 9 is connected to the SAN. The fibre channel switch 9 includes a SAN connection data storage 91. In addition, the fibre channel switch 9 is connected with a storage apparatus 11. The storage apparatus 11 includes host OS activation disks 1 to 3, VM activation disks A to D, and an access data storage 111.

Furthermore, the network switch 5, the servers 1 to 3, the fibre channel switch 9, the storage apparatus 11, an operation manager terminal 17 and a management server 13 are connected with a management LAN 15. The management server 13 has a preliminary setting processor 131, an activation processor 132, a stop processor 133, a movement processor 134, a server VM table 135, a Fibre Channel (FC) table 136 and a LAN table 137.

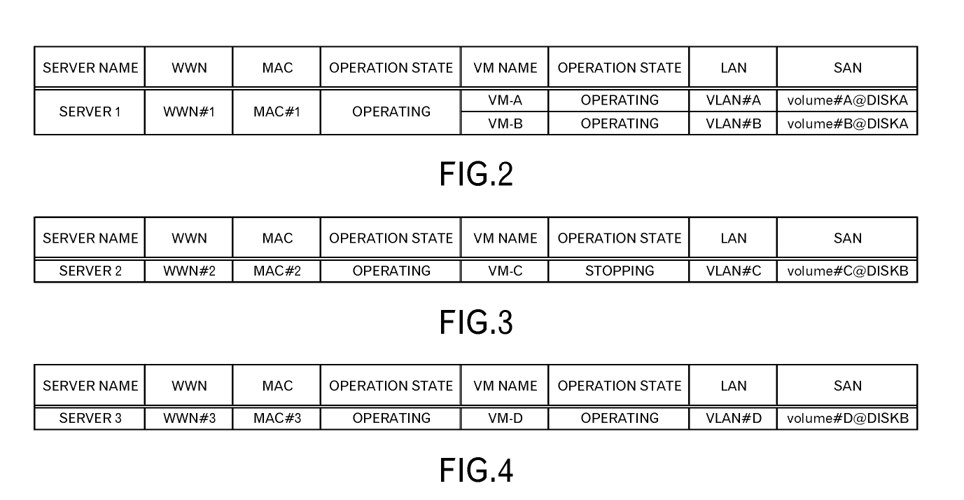

The utilization resource data storage 71 stores data as depicted in FIG. 2, for example. In the table example of FIG. 2, a server name, a World Wide Name (WWN), a MAC address, an operation state of the server, a VM name of the VM being activated, an operation state of the VM, a name of the LAN used by the VM and a name of the SAN used by the VM are registered. Hereinafter, the name of the LAN and the name of SAN may also be called simply “LAN” and “SAN”. Similarly, the utilization resource data storage 72 stores data as depicted in FIG. 3, for example. The data format is the same as that in FIG. 2. In addition, the utilization resource data storage 73 stores data as depicted in FIG. 4, for example. The data format is the same as that in FIG. 2. Incidentally, the VM-A, VM-B and VM-D are being operated, however, as depicted in FIG. 3, the VM-C is stopped. Each host OS manages such data.

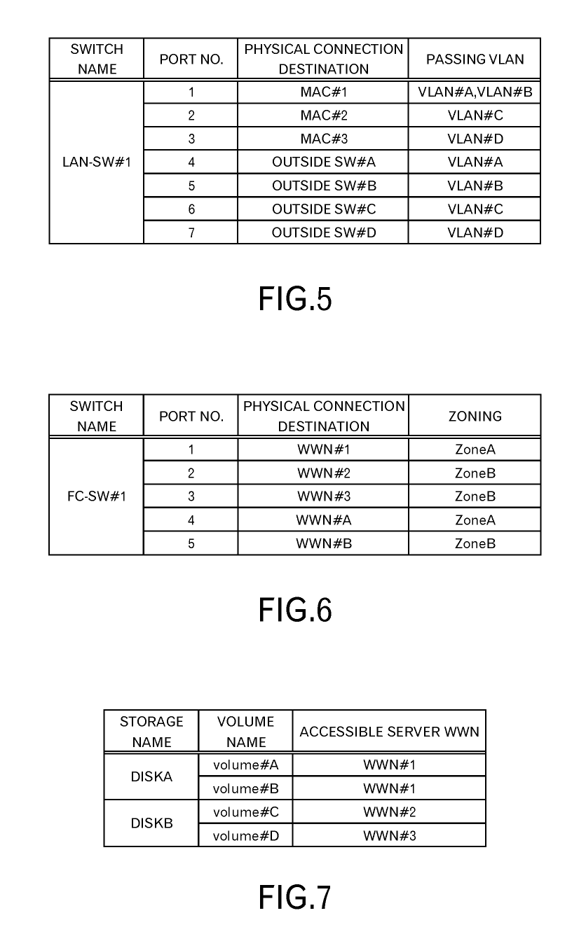

Moreover, the LAN connection data storage 51 stores data as depicted in FIG. 5, for example. In the table example of FIG. 5, a switch name, a port number, a physical connection destination (e.g. address or the like) and a name of a passage VLAN name are registered. The network switch 5 manages such data, and carries out switching according to this data.

Furthermore, the SAN connection data storage 91 stores data as depicted in FIG. 6, for example. In the table example of FIG. 6, a switch name of the FC, a port number, a physical connection destination (WWN) and a zoning are registered. The fibre channel switch 9 manages such data, and carries out the switching according to this data.

In addition, the access data storage 111 stores data as depicted in FIG. 7, for example. In the table example of FIG. 7, a storage name, a volume name and a WWN of an accessible server are registered. The storage apparatus 11 manages such data, and carries out access control according to this data. In this embodiment, it can be understood that DISKA and DISKB in the storage apparatus 11 are activation disks of the VMs.

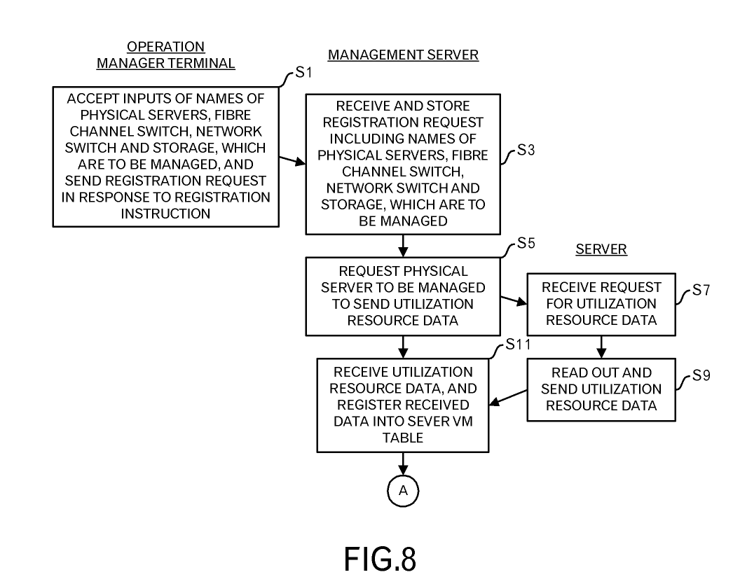

Next, an operation of the system depicted in FIG. 1 will be explained by using FIGS. 8 to 36. First, a preliminary setting processing will be explained by using FIGS. 8 to 13. First, the operation manager terminal 17 accepts inputs of a name of a physical server to be managed, a fibre channel switch name, a network switch name and a storage name from the operation manager, and transmits a registration request including those apparatus names to the management server 13, in response to this registration instruction (step S1). The preliminary setting processor 131 of the management server 13 receives the registration request including the name of the physical server to be managed, the fibre channel switch name and the storage name from the operation manager terminal 17, and stores the request into a storage device such as a main memory (step S3). Then, the preliminary setting processor 131 transmits a request for the utilization resource data (e.g. the connection configuration data of the server, the utilization resource data of the VM, the operation state data and the like) to each physical server to be managed (step S5). The OS of each physical server receives the request for the utilization resource data from the management server 13 (step S7), reads out the utilization resource data from the utilization resource data storage, and transmits the read utilization resource data to the management server 13 (step S9).

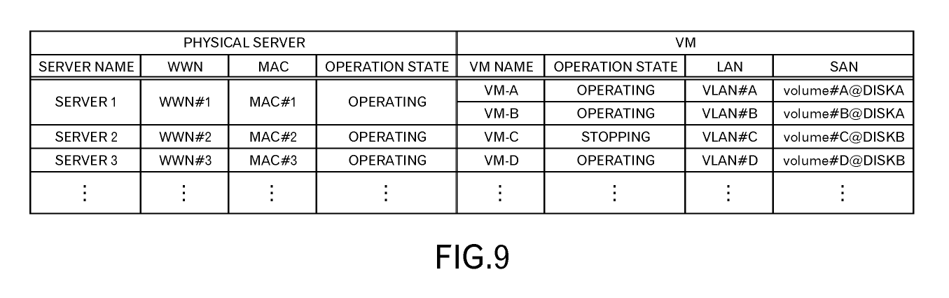

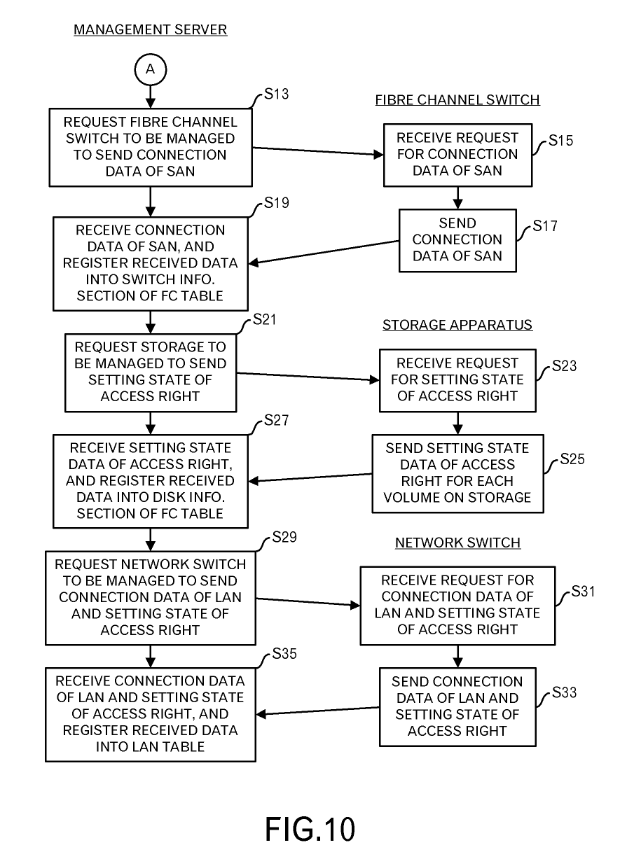

The preliminary setting processor 131 of the management server 13 receives the utilization resource data from each physical server to be managed, and stores the utilization resource data into the server VM table 135 (step S11). For example, when the utilization resource data is received from the servers 1 to 3, the data as depicted in FIG. 9 is registered into the server VM table 135. Namely, data is registered in a format that data depicted in FIGS. 2 to 4 is integrated. Incidentally, the processing shifts to a processing of FIG. 10 through a terminal A.

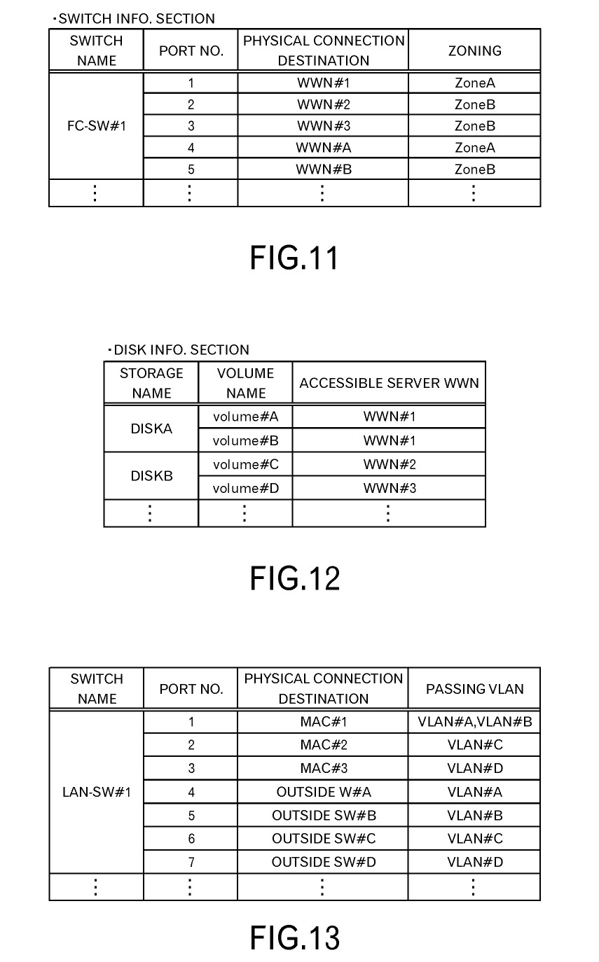

In addition, the preliminary setting processor 131 of the management server 13 requests connection data of the SAN to each fibre channel switch 9 to be managed (step S13). Each of the fibre channel switches 9 receives the request of the connection data of the SAN (step S15), reads out the connection data of the SAN from the SAN connection data storage 91, and transmits the connection data to the management server 13 (step S17). The preliminary setting processor 131 of the management server 13 receives the connection data of the SAN from the fibre channel switches 9, and registers the connection data into a switch information section of the FC table 136 (step S19). For example, the data as depicted in FIG. 11 is stored in the switch information section of the FC table 136. Namely, the data depicted in FIG. 6 is stored into the switch information section of the FC table 136.

Furthermore, the preliminary setting processor 131 of the management server 13 requests a setting state of the access right for each storage apparatus 11 to be managed (step S21). Each of the storage apparatuses 11 to be managed receives the request for the setting state of the access right from the management server 13 (step S23), reads out the setting state data of the access right for each volume on the storage, from the access data storage 111, and transmits the setting state data to the management server 13 (step S25). The management server 13 receives the setting state data of the access right from each of the storage apparatuses 11, and registers the setting state data into a disk information section of the FC table 136 (step S27). For example, the data as depicted in FIG. 12 is stored into the disk information section of the FC table 136. Namely, the data depicted in FIG. 7 is stored into the disk information section of the FC table 136.

Moreover, the preliminary setting processor 131 of the management server 13 requests the connection data of the LAN and the setting state of the access right for each network switch 5 to be managed (step S29). Each of the network switches 5 to be managed receives the request for the connection data of the LAN and the setting state of the access right (step S31), reads out the connection data of the LAN and the setting state data of the access right from the LAN connection data storage 51, and transmits the read data to the management server 13 (step S33). The preliminary setting processor 131 of the management server 13 receives the connection data of the LAN and the setting state data of the access right from the respective network switches 5, and registers the received data into the LAN table 137 (step S35). For example, data as depicted in FIG. 13 is stored into the LAN table 137. Namely, the data as depicted in FIG. 5 is stored in the LAN table 137.

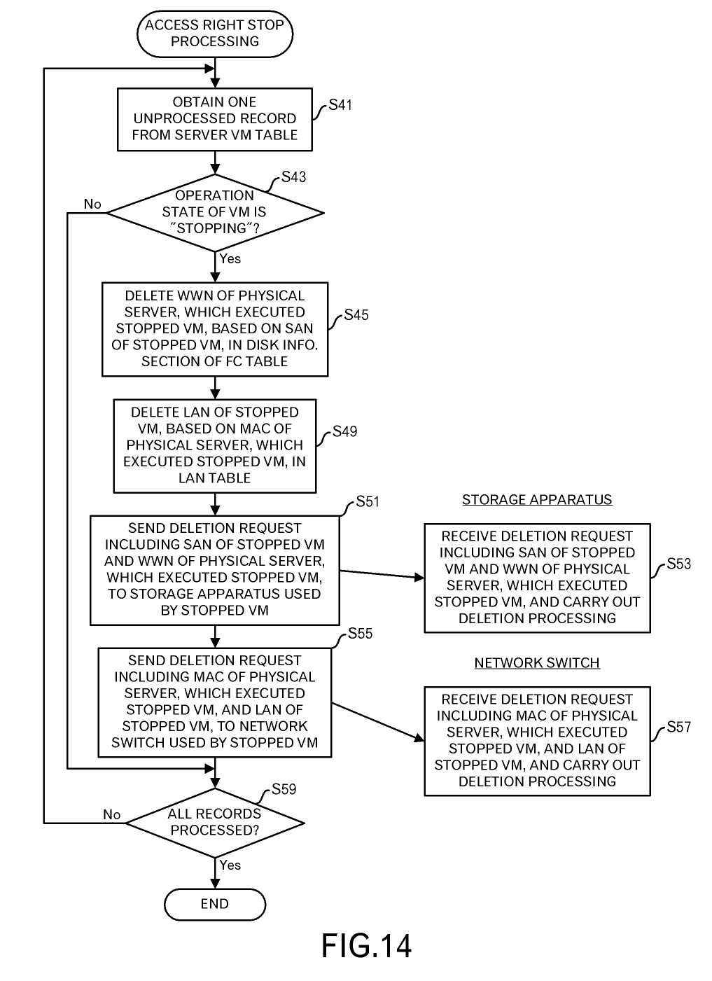

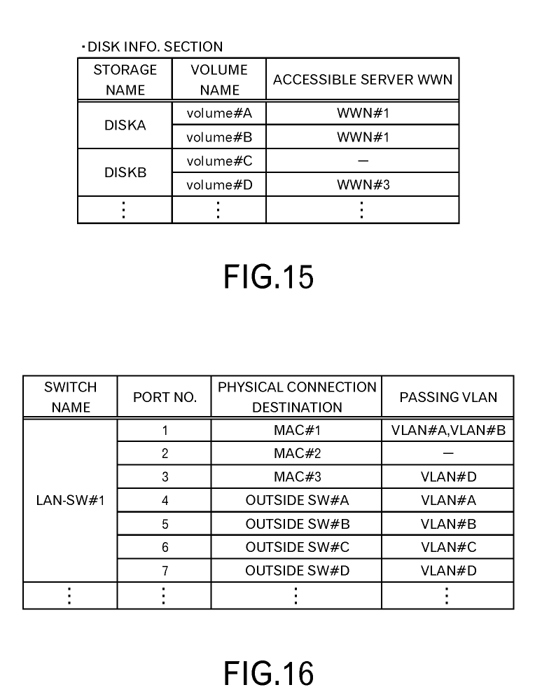

Next, an initial access right stop processing to be carried out after the preliminary setting will be explained by using FIGS. 14 to 16. The stop processor 133 of the management server 13 reads out one unprocessed record from the server VM table 135 (step S41). Then, the stop processor 133 judges whether or not the operation state of the VM indicates “stopping” in the read record (step S43). When the operation state indicates a state other than “stopping”, such as “operating”, the processing shifts to step S59. On the other hand, when the operation state indicates “stopping”, the stop processor 133 deletes the WWN of the physical server on which the stopped VM was executed, in the disk information section of the FC table 136 (step S45). For example, when the state of the server VM table 135 depicted in FIG. 9 indicates the VM-C is in “stopping”, “WWN#2”, which is a WWN of the physical server on which the stopped VM was executed, is deleted in the disk information section of the FC table 136 depicted in FIG. 12 based on the SAN “volume#C@DISKB” of the stopped VM. Therefore, the disk information of the FC table 136 in FIG. 12 is changed to a state of FIG. 15.

Next, the stop processor 133 deletes the LAN of the stopped VM in the LAN table 137 based on the MAC address of the physical server on which the stopped VM in the read record was executed (step S49). Namely, when the state of the server VM table 135 depicted, for example, in FIG. 9 indicates the VM-C is in “stopping”, the stop processor 133 deletes the LAN (i.e. VLAN#C) of the stopped VM in the LAN table 137 depicted in FIG. 13 based on the MAC address “MAC#2” of the physical server on which the stopped VM was executed. Therefore, the LAN table 137 in FIG. 13 changes to a state as depicted in FIG. 16.

Incidentally, in this specific example, the switch information section of the FC table 136 does not change. This is because the physical server has only one WWN. For example, when the disk apparatuses used by the host OS and VM are different and are connected to two ports of the fibre channel switch, the WWN, which is not used, is deleted among the WWNs of the physical server on which the stopped VM was executed, in the switch information section in the FC table 136.

Then, the stop processor 133 transmits a deletion request including the SAN of the stopped VM and the WWN of the physical server on which the stopped VM was executed, to the storage apparatus (which is identified from the SAN corresponding to the stopped VM in the server VM table 135, for example) utilized by the stopped VM (step S51). The storage apparatus 11, utilized by the stopped VM receives the deletion request including the SAN of the stopped VM and the WWN of the physical server on which the stopped VM was executed, and carries out a deletion processing according to the deletion request (step S53). Namely, based on the SAN “volume#C@DISKB” of the stopped VM, “WWN#2”, which is a WWN of the physical server on which the stopped VM was executed, is deleted from the access data storage 111.

In addition, the stop processor 133 transmits a deletion request including the MAC address of the physical server on which the stopped VM was executed and the LAN of the stopped VM to a network switch utilized by the stopped VM (e.g. a switch corresponding to the MAC address of the physical server on which the stopped VM was executed and the LAN of the stopped VM in the LAN table 137) (step S55). The network switch 5 utilized by the stopped VM receives the deletion request including the MAC address of the physical server on which the stopped VM was executed and the LAN of the stopped VM, and carries out a deletion processing according to the deletion request (step S57). Namely, based on the MAC address “MAC#2” of the physical server on which the stopped VM was executed, the LAN (i.e. VLAN#C) of the stopped VM is deleted from the LAN connection data storage 51.

Incidentally, in this specific example, data stored in the SAN connection data storage 91 does not change. As described above, for example, when the disk apparatuses used by the host OS and the VM are different and are connected to two ports of the fibre channel switch, the stop processor 133 transmits the deletion request of the WWN, which is not used among the WWMs of the physical server on which the stopped VM was executed, to the fibre channel switch 9, and the fibre channel switch 9 deletes the WWN, which is not used, from the SAN connection data storage 91, among the WWNs of the physical server on which the stopped VM was executed.

Then, the stop processor 133 judges whether or not all records have been processed in the server VM table 135 (step S59). When an unprocessed record exists, the processing returns to the step S41. On the other hand, when all records have been processed, the processing ends.

Thus, it is possible to delete unnecessary data for the stopped VM in the initial state and to carry out settings relating to the deleted data for the network switch 5, fibre channel switch 9 and the storage apparatus 11.

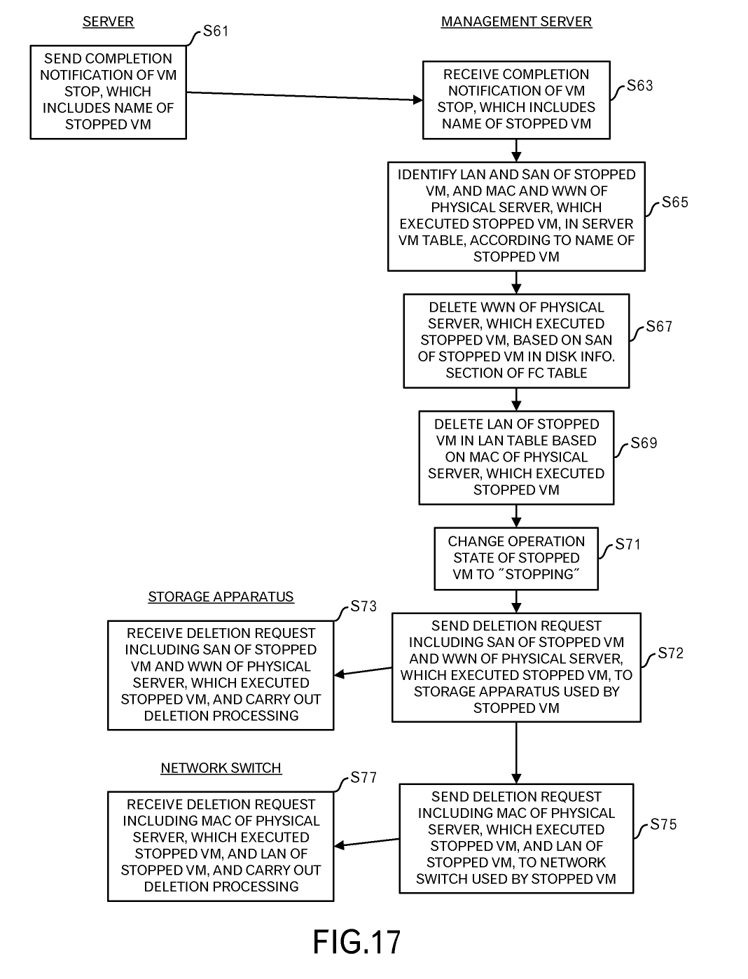

Next, a processing when the stop of a specific VM is notified on the way will be explained by using FIG. 17. First, when the stop of the specific VM is instructed from the user or the like, the host OS of the server carries out a well-known and predetermined VM stop processing, and when the VM stop processing is completed, the host OS transmits a completion notification of the VM stop, which includes a name of the stopped VM, to the management server 13 (step S61). For example, the host OS2 of the server 2 notifies the stop of the VM-C. Then, the stop processor 133 of the management server 13 receives the completion notification of the VM stop, which includes the name of the stopped VM, from the server (step S63). Then, the stop processor 133 searches the server VM table 135 for the name of the stopped VM to identify the LAN and SAN of the stopped VM, and the MAC address and WWN of the physical server on which the stopped VM was executed (step S65).

Then, the stop processor 133 deletes the WWN of the physical server on which the stopped VM was executed, in the disk information section of the FC table 136, based on the SAN of the stopped VM (step S67). For example, when it is notified that the VM-C is in “stopping”, “WWN#2”, which is a WWN of the physical server on which the stopped VM was executed, is deleted in the disk information section of the FC table 136 depicted in FIG. 12, based on the SAN “volume#C@DISKB” of the stopped VM. Therefore, the disk information of the FC table 136 in FIG. 12 changes to a state as depicted in FIG. 15.

In addition, the stop processor 133 deletes the LAN of the stopped VM in the LAN table 137 based on the MAC address of the physical server on which the stopped VM was executed (step S69). For example, when it is notified that the VM-C is in “stopping”, the LAN (i.e. VLAN#C) of the stopped VM is deleted in the LAN table 137 depicted in FIG. 13 based on the MAC address “MAC#2” of the physical server on which the stopped VM was executed. Therefore, the LAN table 137 of FIG. 13 changes to a state as depicted in FIG. 16.

Incidentally, in this specific example, the switch information section of the FC table 136 does not change. For example, when the disk apparatuses used by the host OS and VM are different and are connected with two ports of the fibre channel switch, the WWN, which is not used among the WWNs of the physical server on which the stopped VM was executed, is deleted in the switch information section of the FC table 136.

Then, the stopped VM 133 changes the operation state of the stopped VM to “stopping” in the server VM table 135 (step S71).

In addition, the stop processor 133 transmits a deletion request including the SAN of the stopped VM and the WWN of the physical server on which the stopped VM was executed to the storage apparatus (which is identified from the SAN corresponding to the stopped VM in the server VM table 135, for example) used by the stopped VM. The storage apparatus 11 used by the stopped VM receives the deletion request including the SAN of the stopped VM and the WWN of the physical server on which the stopped VM was executed from the management server 13, and carries out a deletion processing according to the deletion request (step S73). Namely, based on the SAN “volume#C@DISKB” of the stopped VM, “WWN#2”, which is a WWN of the physical server on which the stopped VM was executed, is deleted from the access data storage 111.

In addition, the stop processor 133 transmits a deletion request including the MAC address of the physical server on which the stopped VM was executed and the LAN of the stopped VM to a network switch used by the stopped VM (e.g. a switch corresponding to the LAN of the stopped VM and the MAC address of the physical server on which the stopped VM was executed in the LAN table 137) (step S75). The network switch 5 used by the stopped VM receives the deletion request including the MAC address of the physical server on which the stopped VM was executed and the LAN of the stopped VM, and carries out a deletion processing according to the deletion request (step S77). Namely, based on the MAC address “MAC#2” of the physical server on which the stopped VM was executed, the LAN (i.e. VLAN#C) of the stopped VM is deleted from the LAN connection data storage 51.

Incidentally, in this specific example, data stored in the SAN connection data storage 91 does not change. As described above, for example, when the disk apparatuses used by the host OS and VM are different and are connected with two ports of the fibre channel switch, the stop processor 133 transmits a deletion request of the WWN, which is not used among the WWNs of the physical server on which the stopped VM was executed, to the fibre channel switch 9, and the fibre channel switch 9 deletes the WWN, which is not used, among the WWNs of the physical server on which the stopped VM was executed, from the SAN connection data storage 91.

As described above, even when the VM is stopped due to any reasons, it is possible to prevent unappropriate accesses from being generated, by releasing the settings for the stopped VM in the storage apparatus, the network switch and the like.

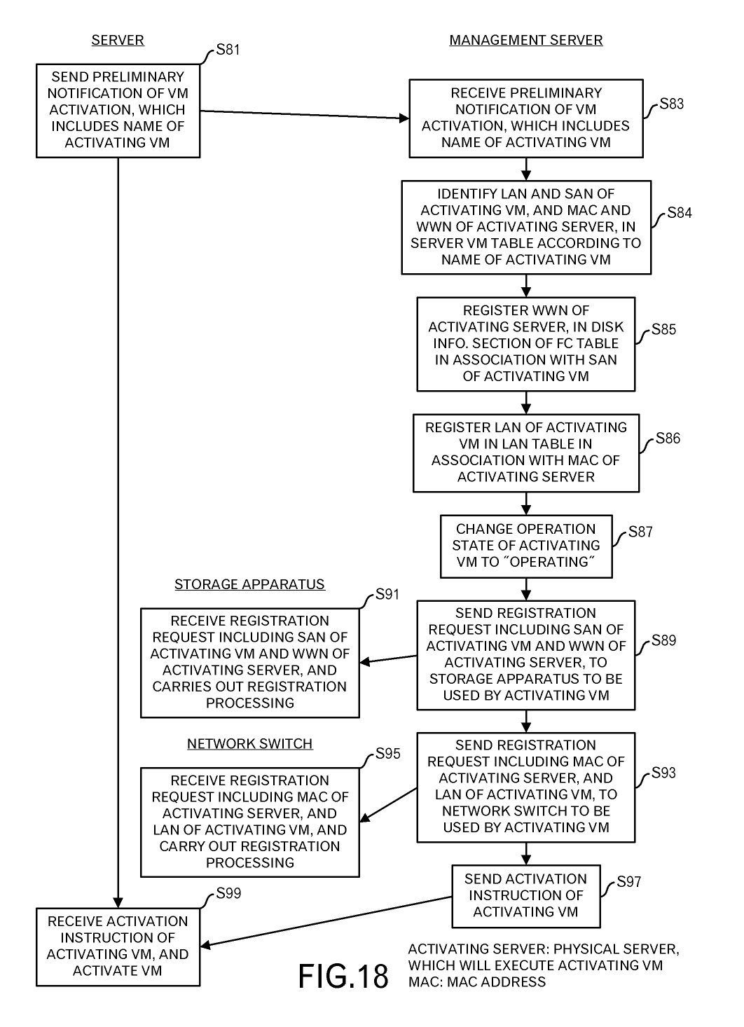

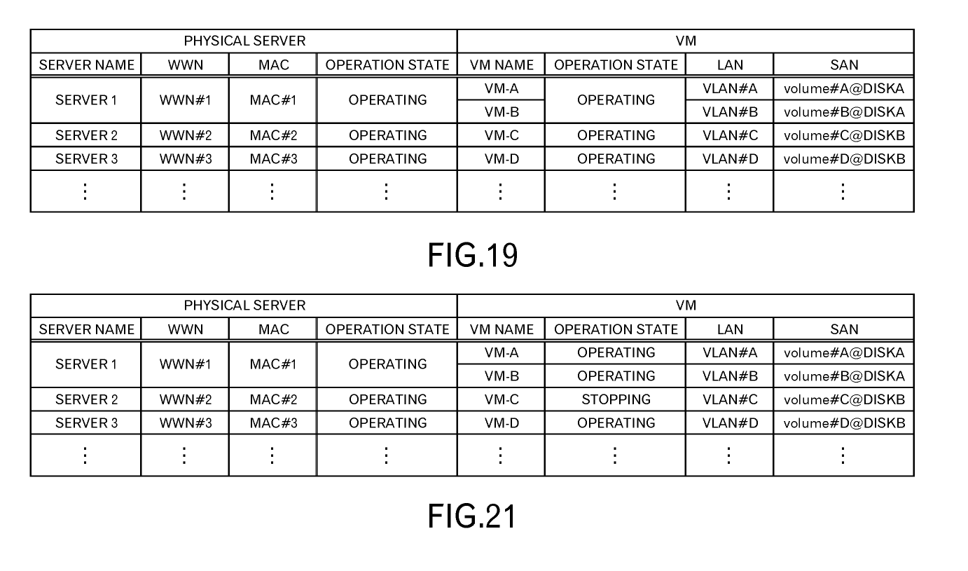

Next, a processing when the activation of a specific VM is notified on the way will be explained by using FIGS. 18 and 19. First, when the activation of the specific VM is instructed from the user or the like, the host OS of the server transmits a preliminary notification of the VM activation, which includes the name of the activating VM (step S81). For example, it is assumed that the VM-C is activated on the host OS2. The activation processor 132 of the management server 13 receives the preliminary notification of the VM activation, which includes the name of the activating VM, from the server (step S83). Then, the activation processor 132 identifies the LAN and SAN of the activating VM, and the MAC address and WWN of the physical server on which the activating VM is executed, in the server VM table 135 according to the name of the activating VM (step S84).

After that, the activation processor 132 registers, in the disk information section of the FC table 136, the WWN of the physical server on which the activating VM is executed, in association with the SAN of the activating VM (step S85). In the disk information section of the FC table 136, the state of FIG. 15 returns to the state of FIG. 12.

Furthermore, the activation processor 132 registers, in the LAN table 137, the LAN of the activating VM in association with the MAC address of the physical server on which the activating VM is executed (step S86). As for the LAN table 137, the state of FIG. 16 returns to the state of FIG. 13.

Incidentally, in this specific example, the switch information section of the FC table 136 does not change. However, for example, when the disk apparatuses used by the host OS and the VM are different and are connected with two ports of the fibre channel switch, the WWN to be used in this case are registered in the switch information section of the FC table 136.

In addition, the activation processor 132 changes the operation state of the activating VM to “operating” in the server VM table 135 (step S87). For example, in the server VM table 135, the state depicted in FIG. 9 is changed to a state depicted in FIG. 19.

Then, the activation processor 132 transmits a registration request including the SAN of the activating VM and the WWN of the physical server on which the activating VM is executed, to the storage apparatus (which is identified from the SAN corresponding to the activating VM in the server VM table 135, for example) used by the activating VM (step S89). The storage apparatus 11 receives the registration request including the SAN of the activating VM and the WWN of the physical server on which the activating VM is executed, and carries out a registration processing for the access data storage 111 (step S91). Based on the SAN “volume#C@DISKB” of the activating VM, “WWN#2”, which is a WWN of the physical server on which the activating VM is executed, is registered into the access data storage 111.

In addition, the activation processor 132 transmits a registration request including the MAC address of the physical server on which the activating VM is executed and the LAN of the activating VM to the network switch to be used by the activating VM (e.g. a switch corresponding to the LAN of the activating VM and the MAC address of the physical server on which the activating VM is executed, in the LAN table 137) (step S93). The network switch 5 receives the registration request including the MAC address of the physical server on which the activating VM is executed and the LAN of the activating VM, and carries out a registration processing for the LAN connection data storage 51 (step S95). Based on the MAC address “MAC#2” of the physical server on which the activating VM is executed, the LAN (i.e. VLAN#C) of the activating VM is registered in the LAN connection data storage 51.

Incidentally, in this specific example, data stored in the SAN connection data storage 91 does not change. As described above, for example, when the disk apparatuses used by the host OS and the VM are different and are connected to two ports of the fibre channel switch, the activation processor 132 transmits a registration request of WWN to be used by the activating VM at this time to the fibre channel switch 9, and the fibre channel switch 9 registers the WWN to be used by the activating VM into the SAN connection data storage 91.

Then, the activation processor 132 transmits an activation instruction to a transmission source server of the preliminary notification of the activating VM (step S97). The host OS of the server receives the activation instruction of the activating VM from the management server 13, and carried out a well-known processing for activating the VM (step S99).

Thus, it becomes possible for the VM to be activated on the way to access necessary resources.

Incidentally, in case where the VM is newly activated, by including data of the LAN and SAN of the VM and the like into the preliminary notification, necessary data is registered into the server VM table 135 and the like by using the data included in the preliminary notification.

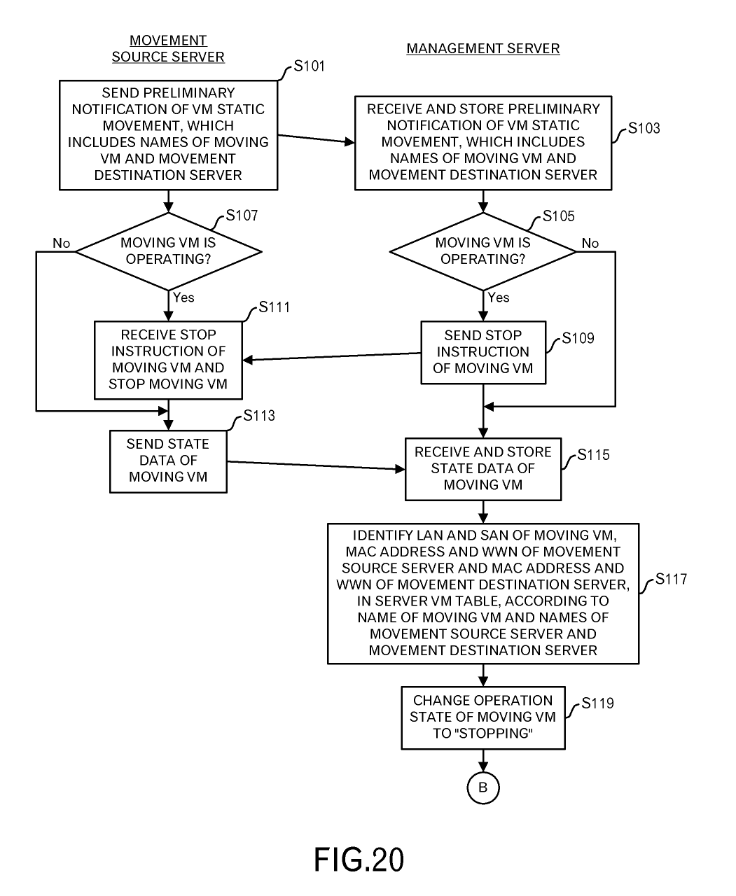

Next, a processing carried out when the VM statically moves will be explained by using FIGS. 20 to 28. First, when the static movement of a specific VM to a specific server is instructed by the user or the like, the host OS of a movement source server transmits a preliminary notification of the static movement of the VM, which includes a name of a moving VM and a name of a movement destination server (step S101). For example, it is presupposed that the VM-C in the host OS2 of the server 2 is moved to the server 3.

The movement processor 134 of the management server 13 receives the preliminary notification of the static movement of the VM, which includes the name of the moving VM and the name of the movement destination server, from the movement source server, and stores the preliminary notification into a storage device such as a main memory (step S103). The movement processor 134 searches the server VM table 135 for the moving VM, and judges whether or not the moving VM is in “moving” (step S105). When the movement VM is not in “moving”, the processing shifts to step S115. On the other hand, when the moving VM is in “moving”, the movement processor 134 transmits a stop instruction of the moving VM to the movement source server (step S109).

When the moving VM is operating (step S107: Yes route), the host OS of the movement source server receives the stop instruction of the moving VM, and carries out a well-known and predetermined VM stop processing (step S111). When the moving VM is not operating (step S107: No route), or after the step S111, the host OS of the movement source server transmits state data (also called configuration information. A state of CPU, a state of memory, a state of I/O, a state of storage, a state of network and the like) of the moving VM to the management server 13 (step S113).

The movement processor 134 of the management server 13 receives the state data of the moving VM from the movement source server, and stores the state data into the storage device such as the main memory (step S115). Then, the movement processor 134 reads out the LAN and SAN of the moving VM, the MAC address and WWN of the movement source server and the MAC address and WWN of the movement destination server according to the name of the moving VM and the names of the movement source server and the movement destination server from the server VM table 135 (step S117).

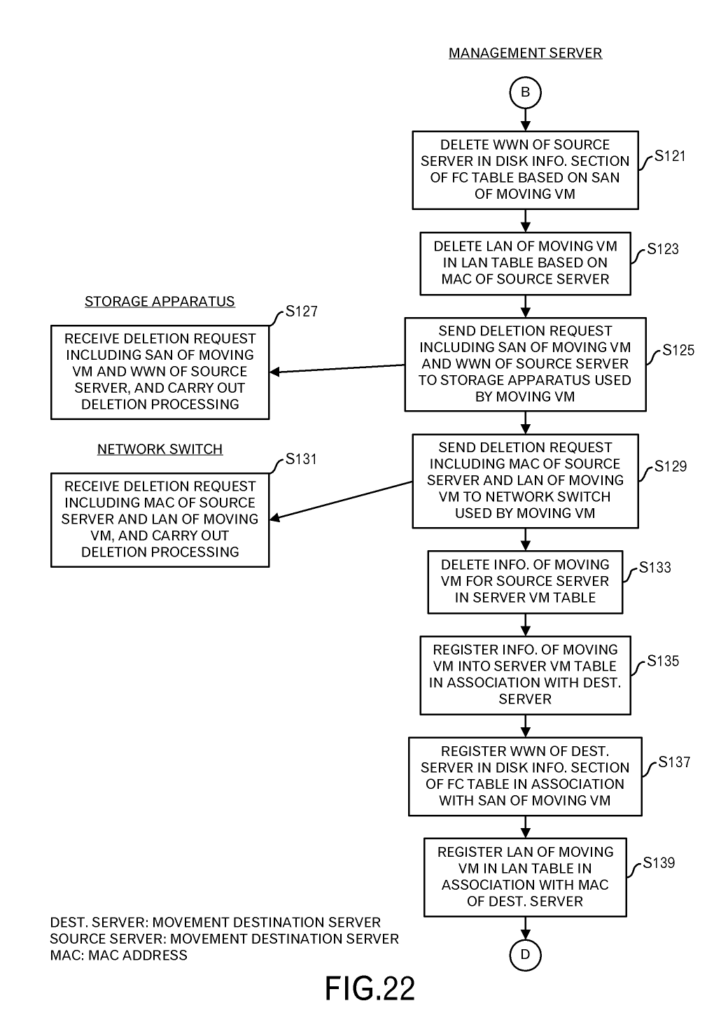

In addition, the movement processor 134 changes the operation state of the moving VM to “stopping” in the server VM table 135 (step S119). The server VM table 135 changes to a state as depicted in FIG. 21, for example. Then, the processing shifts to a processing in FIG. 22 through a terminal B.

Shifting to the explanation of the processing in FIG. 22, the movement processor 134 deletes the WWN of the movement source server in the disk information section of the FC table 136 based on the SAN of the moving VM (step S121). In the disk information section of the FC table 136 depicted in FIG. 12, “WWN#2”, which is a WWN of the movement source server, is deleted based on the SAN “volume#C@DISKB” of the moving VM. Therefore, the disk information of the FC table 136 in FIG. 12 is changed to the state as depicted in FIG. 15.

In addition, the movement processor 134 deletes the LAN of the moving VM in the LAN table 137 based on the MAC address of the movement source server (step S123). In the LAN table 137 depicted in FIG. 13, the LAN (i.e. VLAN#C) of the moving VM is deleted based on the MAC address “MAC#2” of the movement source server. Therefore, the LAN table 137 in FIG. 13 changes to the state depicted in FIG. 16.

Incidentally, in this specific example, the switch information section of the FC table 136 does not change. For example, when the disk apparatuses used by the host OS and the VM are different and are connected to two ports of the fibre channel switch, the WWN, which is not used among the WWNs of the movement source server, is deleted in the switch information section of the FC table 136.

In addition, the movement processor 134 transmits a deletion request including the SAN of the moving VM and the WWN of the movement source server to the storage apparatus (which is identified from the SAN corresponding to the moving VM in the server VM table 135, for example), which was used by the moving VM (step S125). The storage apparatus 11, which was used by the moving VM, receives the deletion request including the SAN of the moving VM and the WWN of the movement source server, and carries out a deletion processing according to the deletion request (step S127). Namely, based on the SAN “volume#C@DISKB” of the moving VM, “WWN#2”, which is a WWN of the movement source server, is deleted from the access data storage 111.

In addition, the movement processor 134 transmits a deletion request including the MAC address of the movement source server and the LAN of the moving VM to a network switch (e.g. a switch corresponding to the LAN of the moving VM and the MAC address of the movement source server in the LAN table 137, for example), which was used by the moving VM (step S129). The network switch 5, which was used by the moving VM, receives the deletion request including the MAC address of the movement source server and the LAN of the moving VM, and carries out a deletion processing according to the deletion request (step S131). Namely, based on the MAC address “MAC#2” of the movement source server, the LAN (i.e. VLAN#C) of the moving VM is deleted from the LAN connection data storage 51.

Incidentally, in this specific example, data stored in the SAN connection data storage 91 does not change. As described above, for example, when the disk apparatuses used by the host OS and the VM are different and are connected to two ports of the fibre channel switch, the movement processor 134 transmits a deletion request of the WWN, which is not used among the WWNs of the movement source server, to the fibre channel switch 9, and the fibre channel switch 9 deletes the WWN, which is not used among the WWNs of the movement source server, from the SAN connection data storage 91.

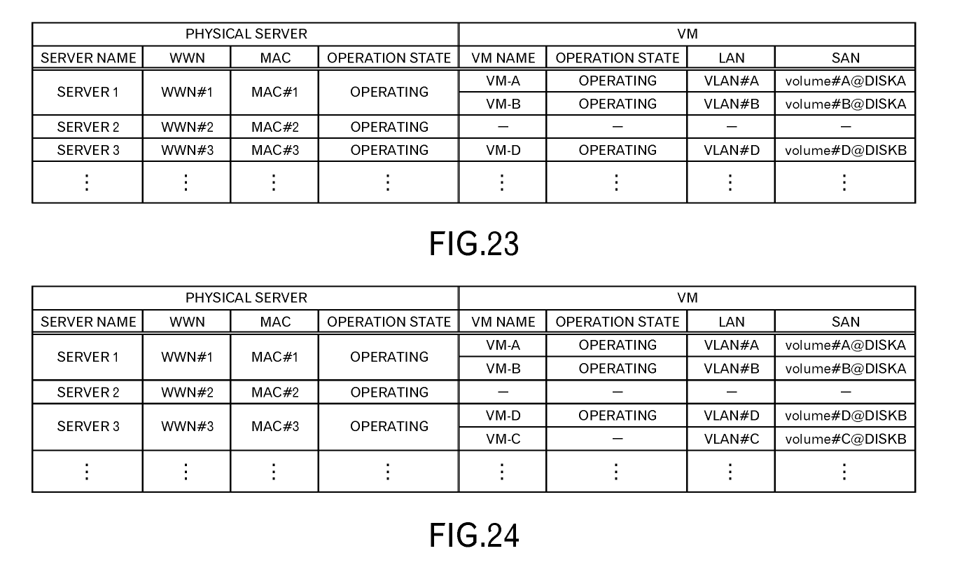

In addition, the movement processor 134 deletes, in the server VM table 135, information (e.g. the VM name, operation state and LAN and SAN) of the movement VM relating to the movement source server (step S133). As for the server VM table 135, the state depicted in FIG. 21 is changed to a state depicted in FIG. 23. Then, the movement processor 134 registers information of the moving VM in the server VM table 135 in association with the movement destination server (step S135). As for the server VM table 135, the state depicted in FIG. 23 is changed to a state depicted in FIG. 24.

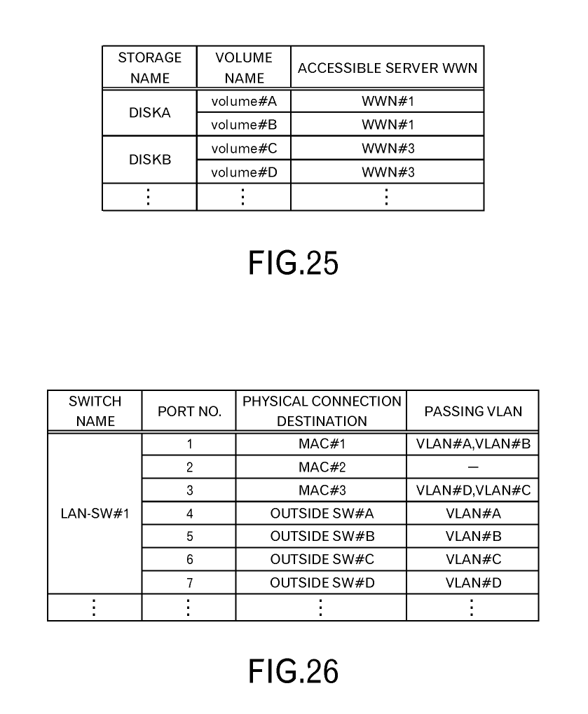

Furthermore, the movement processor 134 registers the WWN of the movement destination server in the disk information section of the FC table 136 in association with the SAN of the moving VM (step S137). In the disk information section of the FC table 136, “WWN#3”, which is a WWN of the movement destination server, is registered based on the SAN “volume#C@DISKB” of the moving VM. Therefore, the disk information of the FC table 136 is changed as depicted in FIG. 25.

In addition, the movement processor 134 registers the LAN of the moving VM in the LAN table 137 based on the MAC address of the movement destination server (step S139). In the LAN table 137, the LAN (e.g. VLAN#C) of the moving VM is registered based on the MAC address “MAC#3” of the movement destination server. Therefore, the LAN table 137 is changed as depicted in FIG. 26.

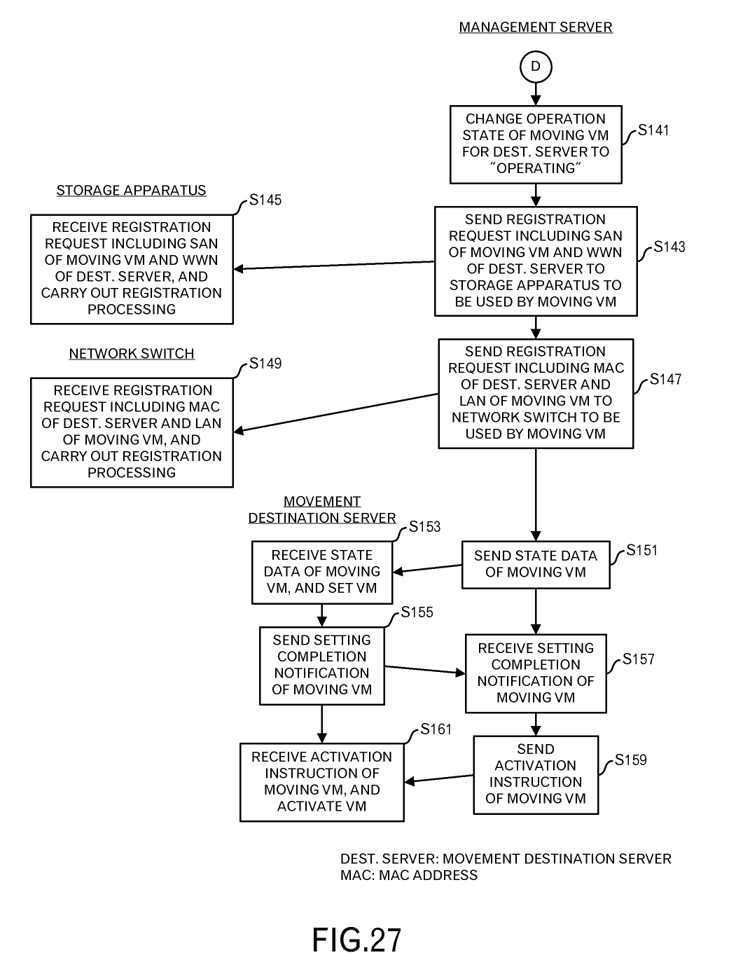

Incidentally, in this specific example, the switch information section of the FC table 136 does not change. For example, when the disk apparatuses used by the host OS and the VM are different and are connected to two ports of the fibre channel switch, the WWN used by the movement destination server is registered in the switch information section of the FC table 136. The processing shifts to a processing of FIG. 27 through a terminal D.

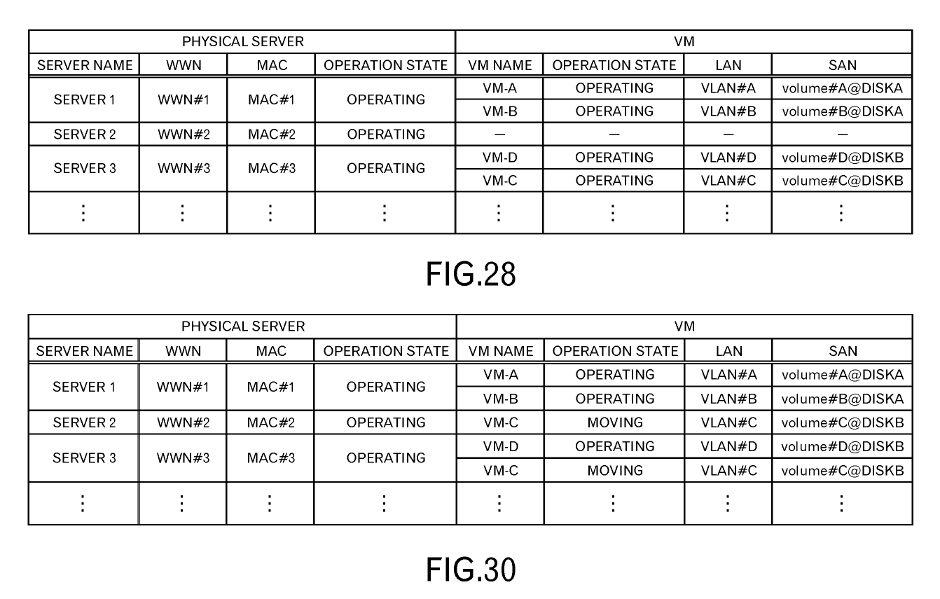

Shifting to the explanation of a processing in FIG. 27, the movement processor 134 changes the operation state of the moving VM relating to the movement destination server to “operating” in the server VM table 135 (step S141). The server VM table 135 is changed to a state as depicted in FIG. 28.

Then, the movement processor 134 transmits a registration request including the SAN of the moving VM and the WWN of the movement destination server to the storage apparatus (which is identified from the SAN corresponding to the moving VM in the server VM table 135, for example) to be used by the moving VM (step S143). The storage apparatus 11 to be used by the moving VM receives the registration request including the SAN of the moving VM and the WWN of the movement destination server, and carries out a registration processing for the access data storage 111 (step S145). Based on the SAN “volume#C@DISKB” of the moving VM, “WWN#3”, which is a WWN of the movement destination server, is registered in the access data storage 111.

In addition, the movement processor 134 transmits a registration request including the MAC address of the movement destination server and the LAN of the moving VM to a network switch (e.g. a switch corresponding to the LAN of the moving VM and the MAC address of the movement destination server in the LAN table 137) to be used by the moving VM (step S147). The network switch 5 to be used by the moving VM receives the registration request including the MAC address of the movement destination server and the LAN of the moving VM, and carries out a registration processing for the LAN connection data storage 51 (step S149). Based on the MAC address “MAC#3” of the movement destination server, the LAN (i.e. VLAN#C) of the moving VM is registered in the LAN connection data storage 51.

Incidentally, in this specific example, data stored in the SAN connection data storage 19 does not change. As described above, for example, when the disk apparatuses used by the host OS and the VM are different and are connected to two ports of the fibre channel switch, the movement processor 134 transmits a registration request of the WWN to be used by the moving VM at this time to the fibre channel switch 9, and the fibre channel switch 9 registers the WWN to be used by the moving VM into the SAN connection data storage 91.

Then, the movement processor 134 transmits state data of the moving VM to the movement destination server (step S151). The host OS (here, host OS3 of the server 3) of the movement destination server receives the state data of the destination VM, and carries out a setting of the VM based on the state data (step S153). The settings of the utilization resource data storage 73 are carried out and a well-known necessary setting processing is carried out. Then, when the setting processing is completed, the host OS of the movement destination server transmits a setting completion notification of the moving VM to the management server 13 (step S155). The movement processor 134 of the management server 13 receives the setting completion notification of the moving VM (step S157), and transmits an activation instruction of the moving VM to the movement destination server (step S159). The host OS of the movement destination server receives the activation instruction of the moving VM from the management server 13, and carries out a well-known activation processing of the VM (step S161).

By carrying out the aforementioned processing, it is possible to carry out the static movement that the activation processing is carried out after the stop processing is temporarily carried out, while preventing the unappropriate accesses.

Incidentally, when the VM management program is included in the host OS, the steps S109 to S115 are omitted because the VM management program carries out the steps. In addition, the steps S151 to S161 are changed to instructions of the movement start for the VM management program. Then, the VM management program carries out a processing for the static movement of the VM.

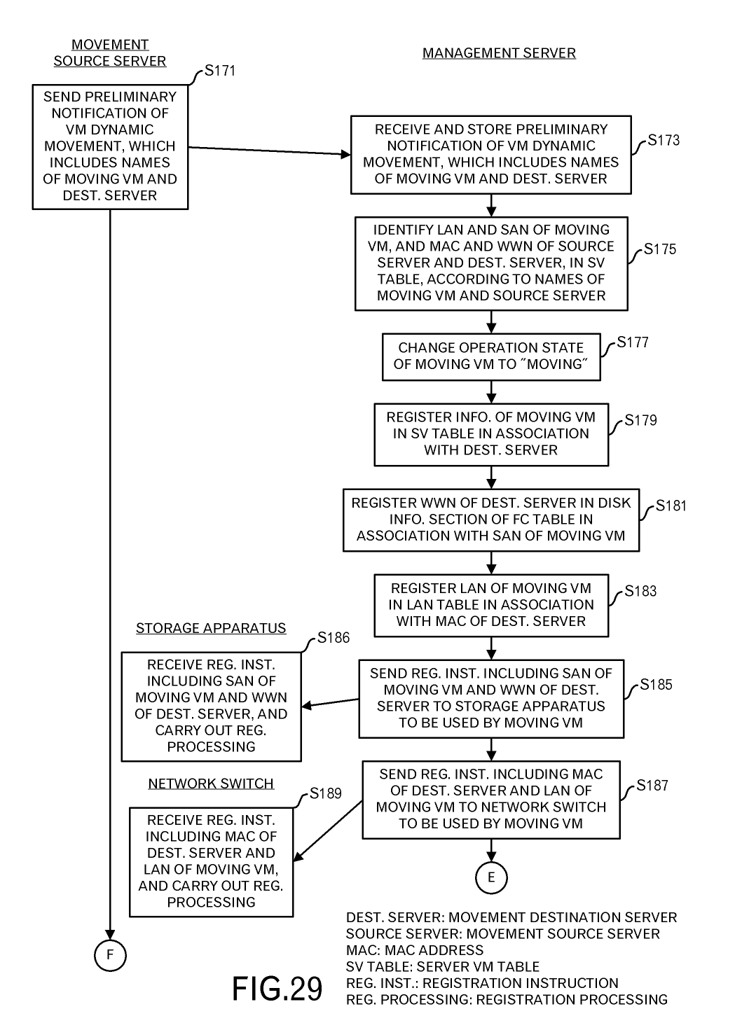

Next, a processing when a dynamic movement of the VM is carried out will be explained by using FIGS. 29 to 36. First, when a dynamic movement of a specific VM to a specific server is instructed from the user and the like, the host OS of the movement source server transmits a preliminary notification of the dynamic movement of the VM, which includes a name of the moving VM and a name of the movement destination server (step S171). For example, it is presupposed that the VM-C in the host OS2 of the server 2 is moved to the server 3.

The movement processor 134 of the management server 13 receives the preliminary notification of the dynamic movement of the VM, which includes the name of the moving VM and the name of the movement destination server, from the movement source server, and stores the notification into the storage device such as the main memory (step S173). The movement processor 134 reads out, from the server VM table 135, the LAN and SAN of the moving VM, the MAC address and WWN of the movement source server, and the MAC address and WWN of the movement destination server according to the name of the moving VM and the names of the movement source server and movement destination server (step S175).

In addition, the movement processor 134 changes the operation state of the moving VM to “moving” in the server VM table 135 (step S177). Furthermore, the movement processor 134 registers information of the moving VM in the server VM table 135 in association with the movement destination server (step S179). The server VM table 135 changes to a state as depicted in FIG. 30, for example.

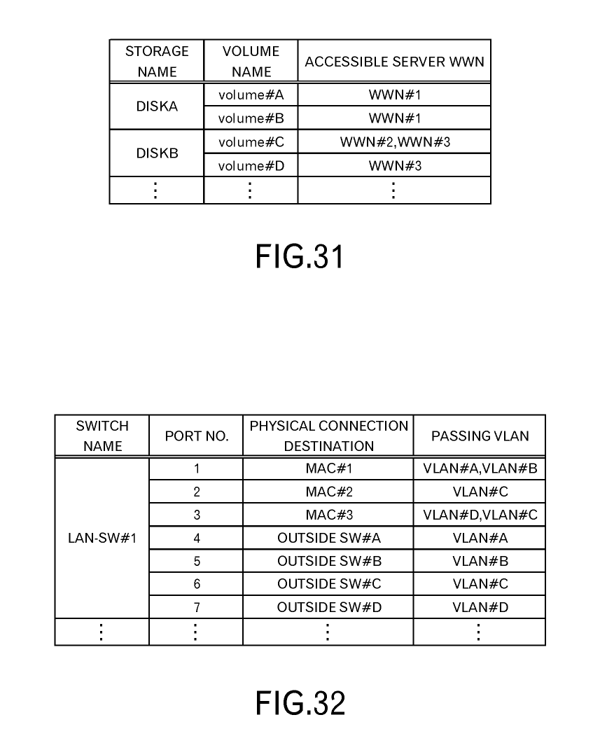

Furthermore, the movement processor 134 registers the WWN of the movement destination server in the disk information section of the FC table 136 in association with the SAN of the moving VM (step S181). In the disk information section of the FC table 136, “WWN#3”, which is a WWN of the movement destination, is additionally registered based on the SAN “volume#C@DISKB” of the moving VM. Therefore, the disk information of the FC table 136 changes to a state as depicted in FIG. 31.

In addition, the movement processor 134 registers the LAN of the moving VM in the LAN table 137 based on the MAC address of the movement destination server (step S183). In the LAN table 137, the LAN (i.e. VLAN#C) of the moving VM is additionally registered based on the MAC address “MAC#3” of the movement destination server. Therefore, the LAN table 137 changes to a state as depicted in FIG. 32.

Incidentally, in this specific example, the switch information section of the FC table 136 does not change. For example, when the disk apparatuses used by the host OS and the VM are different and are connected to two ports of the fibre channel switch, the WWN to be used by the movement destination server is registered in the switch information section of the FC table 136.

Then, the movement processor 134 transmits a registration request including the SAN of the moving VM and the WWN of the movement destination server to the storage apparatus (which is identified from the SAN corresponding to the moving VM in the server VM table 135, for example) to be used by the moving VM (step S185). The storage apparatus 11 to be used by the moving VM receives the registration request including the SAN of the moving VM and the WWN of the movement destination server, and carries out a registration processing for the access data storage 111 (step S186). Based on the SAN “volume#C@DISKB” of the moving VM, “WWN#3”, which is a WWN of the movement destination server, is registered in the access data storage 111.

In addition, the movement processor 134 transmits a registration request including the MAC address of the movement destination server and the LAN of the moving VM to the network switch (e.g. a switch corresponding to the LAN of the moving VM and the MAC address of the movement destination server, for example) to be used by the moving VM (step S187). The network switch 5 to be used by the moving VM receives the registration request including the MAC address of the movement destination server and the LAN of the moving VM, and carries out the registration processing for the LAN connection data storage 51 (step S189). Based on the MAC address “MAC#3” of the movement destination, the LAN (i.e. VLAN#C) of the moving VM is registered in the LAN connection data storage 51.

Incidentally, in this specific example, data stored in the SAN connection data storage 91 does not change. As described above, for example, when the disk apparatus used by the host OS and the VM are different and are connected to two ports of the fibre channel switch, the movement processor 134 transmits a registration request of the WWN to be used by the moving VM at this time to the fibre channel switch 9, and the fibre channel switch 9 registers the WWN to be used by the moving VM into the SAN connection data storage 91.

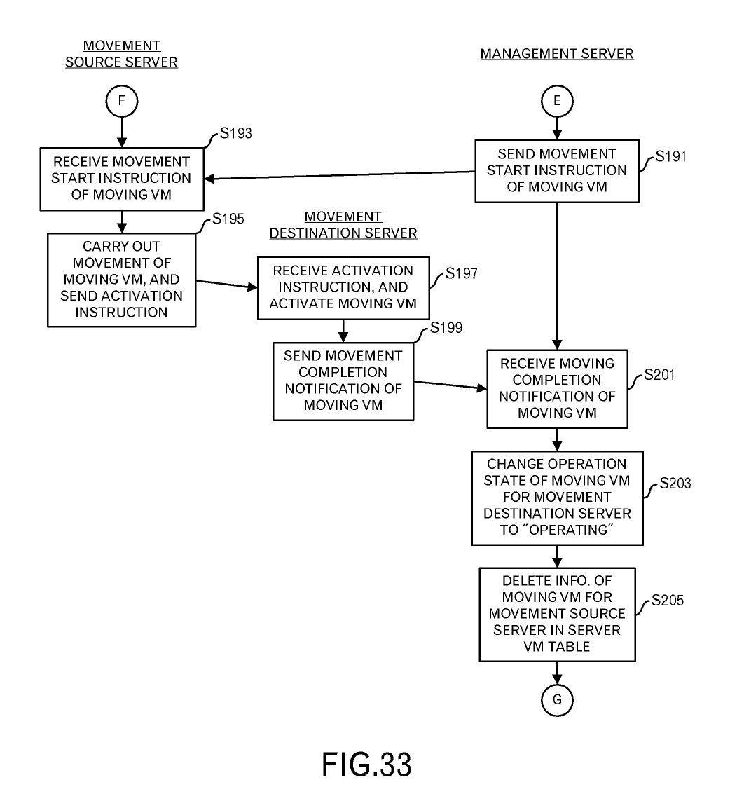

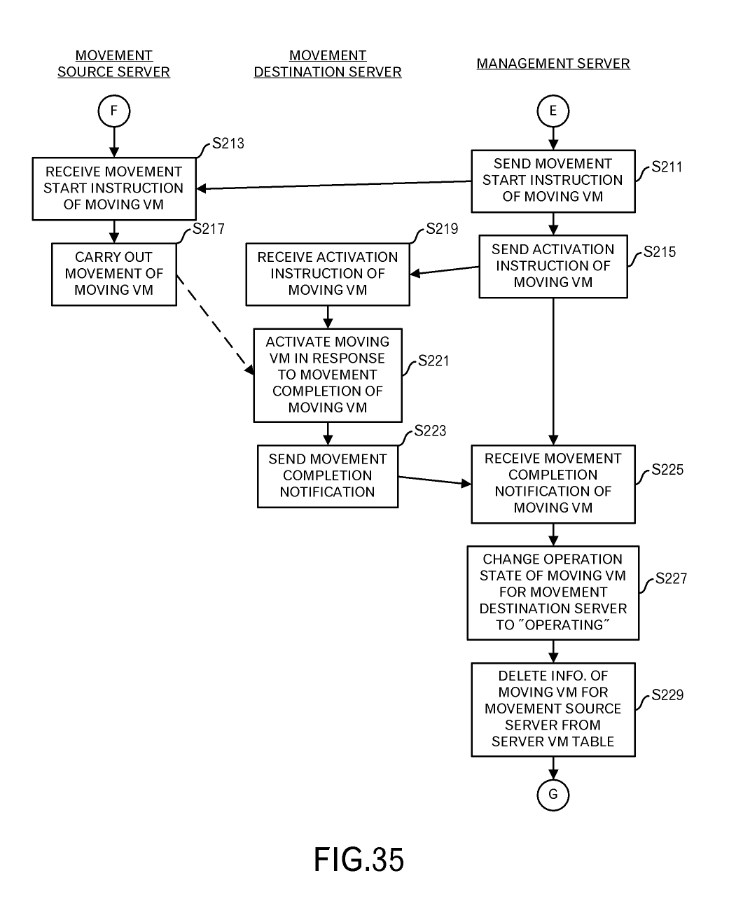

The processing shifts to a processing of FIG. 33 or 35 through terminals E and F.

First, a processing depicted in FIG. 33 will be explained. The movement processor 134 of the management server 13 transmits a movement start instruction of the moving VM to the movement destination server (step S191). The host OS of the movement source server receives the movement start instruction of the moving VM from the management server 13 (step S193). Then, the host OS of the movement source server executes the movement of the moving VM to the movement destination server, and transmits an activation instruction to the movement destination server (step S195). The host OS of the movement destination server receives the activation instruction from the host OS of the movement source server, and carries out activation of the moving VM by using a well-known method (step S197). Then, when the activation of the moving VM is completed, the host OS of the movement destination server transmits a movement completion notification of the moving VM, which includes the name of the moving VM, to the management server 13 (step S199).

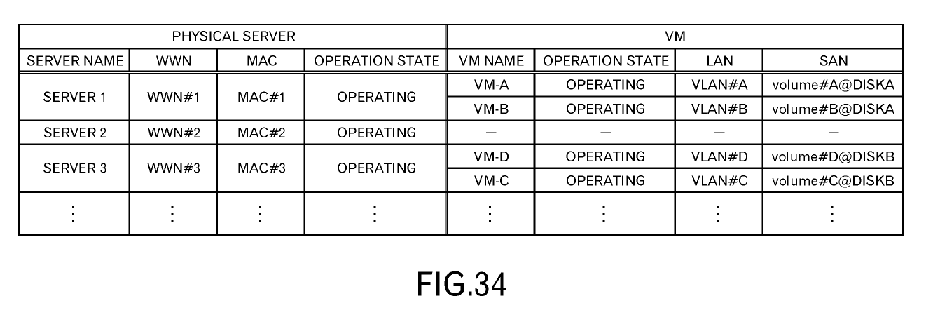

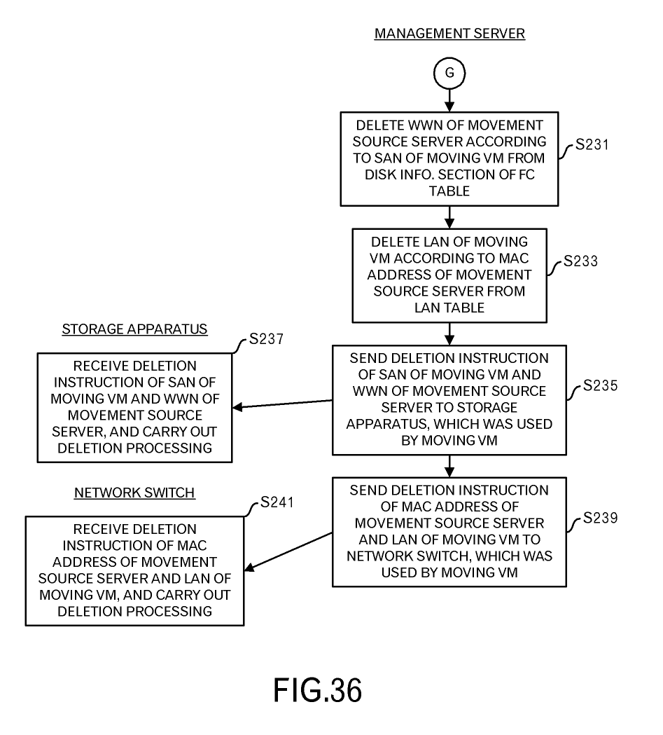

The movement processor 134 of the management server 13 receives the movement completion notification of the moving VM, which includes the name of the moving VM, from the movement destination server (step S201), and changes the operation state of the moving VM for the movement destination server to “operating” (step S203). In addition, the movement processor 134 deletes information (e.g. the VM name, operation state, LAN and SAN) of the moving VM for the movement source server, in the server VM table 135 (step S205). By carrying out this processing, the server VM table 135 is changed to a state as depicted in FIG. 34. Then, the processing shifts to a processing of FIG. 36 through a terminal G.

In addition, as for another embodiment, a processing as depicted in FIG. 35 is carried out instead of the processing in FIG. 33.

In case of FIG. 35, the movement processor 134 of the management server 13 transmits a movement start instruction of the moving VM to the movement source server (step S211). The host OS of the movement source server receives the movement start instruction of the moving VM from the management server 13 (step S213), and carries out a movement processing of the moving VM to the movement destination server (step S217).

In addition, the movement processor 134 of the management server 13 transmits an activation instruction of the moving VM to the movement destination server (step S215). The host OS of the movement destination server receives the activation instruction of the moving VM from the management server 13 (step S219), and carries out a well-known activation processing of the moving VM in response to movement completion of the moving VM (step S221). In addition, the host OS of the movement destination server transmits a movement completion notification to the management server 13 (step S223). The movement processor 134 of the management server 13 receives the movement completion notification from the movement destination server (step S225). Then, the movement processor 134 changes the operation state of the moving VM for the movement destination server to “operating” in the server VM table 135 (step S227). Moreover, the movement processor 134 deletes information (i.e. the VM name, operation state, LAN and SAN) of the moving VM for the movement source server in the server VM table 135 (step S229). By carrying out this processing, the server VM table 135 changes to a state as depicted in FIG. 34. Then, the processing shifts to a processing of FIG. 36 through the terminal G.

The processing after the terminal G will be explained by using FIG. 36. The movement processor 134 of the management server 13 deletes the WWN of the movement source server in the disk information section of the FC table 136, based on the SAN of the moving VM (step S231). In the disk information section of the FC table 136, “WWN#2”, which is a WWN of the movement source server, is deleted based on the SAN “volume#C@DISKB” of the moving VM. Therefore, the disk information of the FC table 136 changes to the state as depicted in FIG. 25.

In addition, the movement processor 134 deletes the LAN of the moving VM in the LAN table 137 based on the MAC address of the movement source server (step S233). In the LAN table 137, the LAN (i.e. VLAN#C) of the movement VM is deleted based on the MAC address “MAC#2” of the movement source server. Therefore, the LAN table 137 changes to the state as depicted in FIG. 26.

Incidentally, in this specific example, the switch information section of the FC table 136 does not change. For example, when the disk apparatuses used by the host OS and the VM are different and are connected to two ports of the fibre channel switch, the WWN, which is not used among the WWNs of the movement source server, is deleted in the switch information section of the FC table 136.

In addition, the movement processor 134 transmits a deletion request including the SAN of the moving VM and the WWN of the movement source server to the storage apparatus (which is identified from the SAN corresponding to the moving VM in the server VM table 135, for example), which the moving VM utilized (step S235). The storage apparatus 11 used by the moving VM receives the deletion request including the SAN of the moving VM and the WWN of the movement source server from the management server 13, and carries out a deletion processing according to the deletion request (step S237). Namely, based on the SAN “volume#C@DISKB” of the moving VM, “WWN#2”, which is the WWN of the movement source server, is deleted from the access data storage 111.

In addition, the movement processor 134 transmits a deletion request including the MAC address of the movement source server and the LAN of the moving VM to the network switch (e.g. a switch corresponding to the LAN of the moving VM and the MAC address of the movement source server in the LAN table 137), which the moving VM utilized (step S239). The network switch 5 utilized by the moving VM receives the deletion request including the MAC address of the movement source server and the LAN of the moving VM, and carries out a deletion processing according to the deletion request (step S241). Namely, based on the MAC address “MAC#2” of the movement source server, the LAN (i.e. VLAN#C) of the moving VM is deleted from the LAN connection data storage 51.

Incidentally, in this specific example, data stored in the SAN connection data storage 91 does not change. As described above, for example, when the disk apparatuses used by the host OS and the VM are different and are connected to two ports of the fibre channel switch, the movement processor 134 transmits a deletion request of the WWN, which is not used among the WWNs of the movement source server, to the fibre channel switch 9, and the fibre channel switch 9 deletes the WWN, which is not used among the WWNs of the movement source server, from the SAN connection data storage 91.

By carrying out such a processing, it becomes possible to carry out the dynamic movement of the VM while preventing unappropriate accesses.

Incidentally, the movement processor 134 of the management server 13 may start the processing in response to an instruction of the movement of the VM from the user.

Although the embodiments of this technique are described, this technique is not limited to the embodiments. For example, the functional block configuration of the management server 13 depicted in FIG. 1 is not always identical with an actual program module configuration.

In addition, the order of the steps can be exchanged as long as the processing results do not change, and the steps may be executed in parallel as long as the processing results do not change.

Incidentally, the management server 13 may be implemented by one computer or plural computers.

In addition, the network configuration to be managed may be changed.

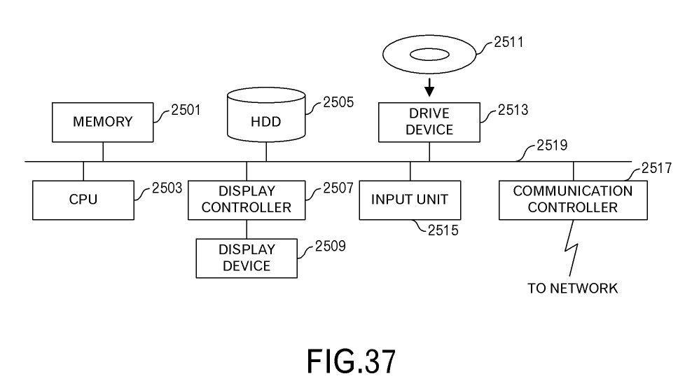

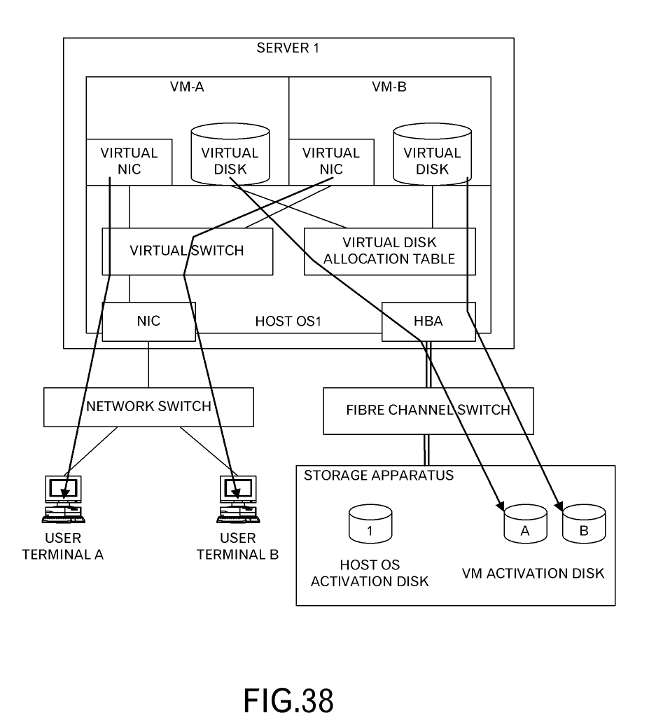

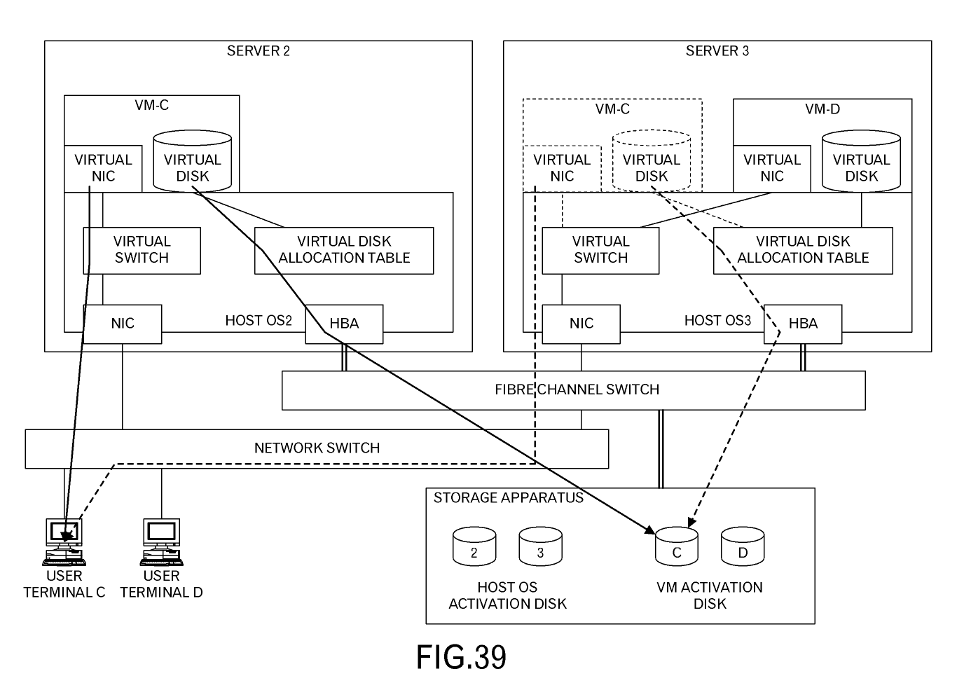

In addition, the management server 13 is a computer device as shown in FIG. 37. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 37. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiments are outlined as follows:

According to one viewpoint of the embodiments, an access authority setting method includes: detecting an action including activation of a virtual machine, stop of the virtual machine or a movement of the virtual machine between physical servers; and setting access authority required for a state after the action to a related apparatus among a connection apparatus and a disk apparatus in a system. Thus, by dynamically resetting the access authority to the connection apparatus or disk apparatus according to an operation state of the virtual machine, the unauthorized access is prevented and the improvement of the security is realized.

Incidentally, the setting the access authority may include: identifying the related apparatus and content to be set to the related apparatus based on a management table for managing connection configuration data of the physical servers and utilization resource data of the virtual machines and an access authority setting state data table storing access authority setting state data in the connection apparatus and the disk apparatus in the system. By adopting such data management, it becomes possible to appropriately identify the setting destination and setting content.

In addition, the aforementioned setting the access authority may include, when the activation of the virtual machine is detected, carrying out a setting of the access authority to the related apparatus based on the utilization resource of the virtual machine and the connection configuration of the physical server on which the virtual machine operates.

Furthermore, the aforementioned setting the access authority may further includes transmitting an activation instruction to the physical server on which the virtual machine operates, after the carrying out the setting.

In addition, the aforementioned carrying out the setting of the access authority may include, when the stop of the virtual machine is detected, carrying out a setting to release the access authority, to the related apparatus, based on the utilization resource of the virtual machine and the connection configuration of the physical server on which the virtual machine operates.

Furthermore, the aforementioned setting the access authority may include, when a static movement of the virtual machine between the physical machines is detected, carrying out a setting to release the access authority, to a first related apparatus among the connection apparatus and the disk apparatus in the system based on the utilization resource of the virtual machine and the connection configuration of a movement source server of the virtual machine; after carrying out the setting to release the access authority, to the first related apparatus, carrying out a setting of the access authority to a second related apparatus among the connection apparatus and the disk apparatus in the system based on the utilization resource of the virtual machine and the connection configuration of a movement destination server of the virtual machine. Thus, the static movement is appropriately carried out.

In addition, the aforementioned setting the access authority may include, when a dynamic movement of the virtual machine between the physical servers is detected carrying out a setting of the access authority to a third related apparatus among the connection apparatus and the disk apparatus in the system based on the utilization resource of the virtual machine and the connection configuration of the movement destination server of the virtual machine; and after the movement of the virtual machine is completed, carrying out a setting to release the access authority, to a fourth related apparatus among the connection apparatus and the disk apparatus in the system, based on the utilization resource of the virtual machine and the connection configuration of the movement source server of the virtual machine. Thus, it becomes possible to appropriately carry out the dynamic movement.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable storage medium storing a program for causing a computer to execute an access authority setting process comprising:
detecting an action including activation of a virtual machine, stop of said virtual machine or a movement of said virtual machine between physical servers; and
setting access authority required for a state after said action to a related apparatus among a connection apparatus and a disk apparatus in a system.

2. The computer-readable storage medium as set forth in claim 1, wherein said setting said access authority comprises:
identifying said related apparatus and content to be set to said related apparatus based on a management table for managing connection configuration data of said physical servers and utilization resource data of said virtual machines and an access authority setting state data table storing access authority setting state data in said connection apparatus and said disk apparatus in said system.

3. The computer-readable storage medium as set forth in claim 1, wherein said setting said access authority comprises:
upon detecting said activation of said virtual machine, carrying out a setting of said access authority to said related apparatus based on a utilization resource of said virtual machine and connection configuration of said physical server on which said virtual machine operates.

4. The computer-readable storage medium as set forth in claim 3, wherein said carrying out said setting of said access authority further comprises transmitting an activation instruction to said physical server on which said virtual machine operates, after said carrying out said setting.

5. The computer-readable storage medium as set forth in claim 1 wherein said setting said access authority comprises:
upon detecting said stop of said virtual machine, carrying out a setting to release said access authority, to said related apparatus, based on a utilization resource of said virtual machine and connection configuration on which said virtual machine operates.

6. The computer-readable storage medium as set forth in claim 1, wherein said setting said access authority comprises:
upon detecting a static movement of said virtual machine between said physical machines, carrying out a setting to release said access authority, to a first related apparatus among said connection apparatus and said disk apparatus in said system based on a utilization resource of said virtual machine and connection configuration of a movement source server of said virtual machine; and
after carrying out said setting to release said access authority, to said first related apparatus, carrying out a setting of said access authority to a second related apparatus among said connection apparatus and said disk apparatus in said system based on said utilization resource of said virtual machine and connection configuration of a movement destination server of said virtual machine.

7. The computer-readable storage medium as set forth in claim 1, wherein said setting said access authority comprises:
upon detecting a dynamic movement of said virtual machine between said physical servers, carrying out a setting of said access authority to a third related apparatus among said connection apparatus and said disk apparatus in the system, based on a utilization resource of said virtual machine and connection configuration of a movement destination server of said virtual machine; and
after said movement of said virtual machine is completed, carrying out a setting to release said access authority, to a fourth relating apparatus among said connection apparatus and said disk apparatus in said system, based on said utilization resource of said virtual machine and connection configuration of a movement source server of said virtual machine.

8. An access authority setting method, comprising:
providing a plurality of physical servers, a connection apparatus connecting said plurality of physical servers and a disk apparatus used by said disk apparatus;
detecting an action including activation of a virtual machine, stop of said virtual machine or a movement of said virtual machine between said physical servers; and
setting access authority required for a state after said action to a related apparatus among said connection apparatus and said disk apparatus in a system.

9. An access authority setting apparatus, comprising:
a hardware network interface with a network connecting a plurality of physical servers, a connection apparatus and a disk apparatus in a system;
a detector to detect an action including activation of a virtual machine, stop of said virtual machine or a movement of said virtual machine between said physical servers; and
a unit to set access authority required for a state after said action to a related apparatus among said connection apparatus and said disk apparatus in a system.
